(19) United States
(12) Patent Application Publication
(10) Pub. No.: US 2024/0062069 A1
(43) Pub. Date: Feb. 22, 2024

(54) INTELLIGENT WORKLOAD ROUTING FOR MICROSERVICES

(71) Applicant: International Business Machines Corporation, Armonk, NY (US)

(72) Inventors: Peng Hui Jiang, Beijing (CN); Sheng Yan Sun, Beijing (CN); Jun Su, Beijing (CN); Su Liu, Austin, TX (US); Jeremy R. Fox, Georgetown, TX (US); Hamid Majdabadi, Ottawa (CA)

(21) Appl. No.: 17/891,430

(22) Filed: Aug. 19, 2022

(51) Int. Cl. G06N 3/092

(52) U.S. Cl. CPC G06N 3/092

(57) ABSTRACT

A system may include a memory and a processor in communication with the memory. The processor may be configured to perform operations. The operations may include training a model. The operations may include enhancing the model with reinforcement learning and improving stability of the model with a graph neural network model. The operations may include predicting, with the model, a resource cost of a node and deploying the node.

### BACKGROUND

The present disclosure relates to distributed system workload management, and, more specifically, to workload management in distributed systems.

Workload scheduling and workload distribution are common functions in the computer field, including in distributed systems. Distributed systems may include, for example, open-source container systems. Open-source containers offer adaptive load balancing, service registration, deployment, operation, resource scheduling, and capacity scaling.

Routing technology may be used to support tools (e.g., orchestration tools) used in various environments, including open-source container environments and other environments that may host microservices, workloads, and the like. Portable routing technologies capable of supporting a range of orchestration tools may, for example, enable a user (e.g., a developer) to deploy a familiar solution and common routing layer model across multiple deployments.

### SUMMARY

Embodiments of the present disclosure include a system, method, and computer program product for intelligent workload routing for microservices.

A system may include a memory and a processor in communication with the memory. The processor may be configured to perform operations. The operations may include training a model. The operations may include enhancing the model with reinforcement learning and improving stability of the model with a graph neural network model. The operations may include predicting, with the model, a resource cost of a node and deploying the node.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a system of intelligent microservice workload routing in accordance with some embodiments of the present disclosure.

FIG. 2 depicts a system of intelligent microservice workload routing in accordance with some embodiments of the present disclosure.

FIG. 3 illustrates a diagram of microservice workload routing in accordance with some embodiments of the present disclosure.

FIG. 4 depicts a computer-implemented method of intelligent workload routing in accordance with some embodiments of the present disclosure.

FIG. 5 illustrates a computer-implemented method of intelligent workload routing in accordance with some embodiments of the present disclosure.

FIG. 6 depicts a cloud computing environment in accordance with embodiments of the present disclosure.

FIG. 7 illustrates abstraction model layers in accordance with embodiments of the present disclosure.

FIG. 8 depicts a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate distributed system workload management, and, more specifically, to workload management in distributed systems.

Routing technology may be used to support various computational tools. Portable routing technologies capable of supporting a range of orchestration tools may reduce various challenges in supporting multiple environments by, for example, deploying a familiar solution and/or a common routing layer model across deployments. Routing technology may be used to reduce or even avoid the impact of various obstacles while maintaining model reliability, fairness, and robustness.

In accordance with the present disclosure, intelligent routing may be generated and used. For example, routing may be enhanced with reinforcement learning to predict and select the next action of each request. In some embodiments, deep reinforcement learning may be used for prediction and estimation; given a large number of calculations completed in the training phase, the model may provide real-time responses to incoming requests.

In some embodiments, resource costs of workloads and/or nodes may be predicted. The resource cost of a workload may be predicted by estimating the minimum consumption of the workload and the maximum consumption of the workload; the difference between the minimum consumption and maximum consumption may be minimized such that the two consumption estimates are nearly identical, thereby improving the precision of the model prediction.

In some embodiments, a callback may be used to update and/or adjust a model. For example, the actual consumption of a workload may be compared to the predicted consumption of a workload to generate a callback; the callback may be used to correct the model used to generate the initial prediction so as to improve future predictions by the model.

Some embodiments of the present disclosure may use reinforcement learning to predict the resource cost of a workload and/or a node, select a next action, and/or maintain the balance of the nodes within the cluster. In some embodiments, the model may initially be trained via simulation; for example, a model may be trained via simulation, used to predict resource costs, and retrained using reinforcement learning.

Some embodiments of the present disclosure may employ a deep neural network (DNN). In some embodiments, the parameters of the DNN may be updated in a short period of time so as to enable the deployment of the model in accordance with a timeline.

Some embodiments of the present disclosure may use a graph neural network (GNN) model to reinforce the stability of a prediction model. For example, a GNN model may be trained for adversarial attacks and used to reduce the noise of the prediction model to improve the predictions made by the prediction model. In some embodiments, the maximum cut method may be used to confirm the model results. For example, a predictive model may be trained using machine learning (ML), improved via a GNN model, and used to predict the resource cost of a workload; the maximum cut method may be used to confirm the prediction of the model.

In accordance with the present disclosure, a system may use a prediction and/or learning approach to provide an intelligent routing solution. In some embodiments, the learning approach may be a classical ML approach and enhanced with a reinforcement learning approach; for example, a prediction model may be trained according to classical ML, enhanced with reinforcement learning, improved using GNN, and used to predict a resource cost in accordance with the present disclosure. In some embodiments, the prediction model may be used to predict a workload resource cost, select a node for the workload, and deploy the node to host the workload.

Routing, which may also be referred to as path selection, may involve applying a routing metric to multiple routes to predict and/or select the best route. Routing algorithms may use one or more network paths at a time. Multipath routing techniques may enable the use of multiple and/or alternative paths for routing; equal-cost multi-path routing techniques, for example, may be used to enable one or more alternative routing paths.

In some embodiments of the present disclosure, standard route parameters may be used similar or the same as in traditional route metric calculations; in some embodiments, related parameters may further be used. For example, a link utilization measurement using simple network management protocol (SNMP), hop count, packet loss (to gauge router conditions and/or congestion), path speed, path reliability, path bandwidth, network delay, maximum transmission unit (MTU), throughput (e.g., using query routers via SNMP), load, administrator configured value(s), application type(s), next service point, before service point, package size, return forecast, and/or similar metrics may be utilized.

In some embodiments of the present disclosure, an artificial neural network (ANN) such as a DNN may be used; an ANN architecture may have an input layer, one or more hidden layers, and an output layer. A DNN may have many hidden layers to capture various metadata. A request may be submitted to a long short-term memory (LSTM) or similar recurrent neural network (RNN). The LSTM may request the history information from the environment file; a convolutional neural network (CNN) layer may integrate the environment file information. The output of the DNN may include the cost of the workload and a node selection. In some embodiments, the cost may be estimated using the difference between the minimum resource consumption and the maximum resource consumption; in some embodiments, the ideal difference between the minimum resource consumption and the maximum resource consumption is zero.

In some embodiments of the present disclosure, reinforcement learning (RL) may be used. RL is a ML technique that allows an agent to learn by performing trial-and-error interactions with the environment. In some ML techniques, the learning method is characterized; in RL techniques, the learning problem is characterized. RL uses rewards obtained by interacting with the environment to signal positive and negative behavior. In some embodiments of the present disclosure, an agent may continuously interact with the routing in a cloud environment to learn the best action for a particular state by collecting rewards and penalties.

A system in accordance with the present disclosure may include a memory and a processor in communication with the memory. The processor may be configured to perform operations. The operations may include training a model. The operations may include enhancing the model with reinforcement learning and improving stability of the model with a graph neural network model. The operations may include predicting, with the model, a resource cost of a workload and deploying a node to host the workload.

In some embodiments of the present disclosure, the operations may include generating a callback with an actual consumption and a predicted consumption and updating the model with the callback.

In some embodiments of the present disclosure, the operations may include estimating a minimum consumption of the node, estimating a maximum consumption of the node, and using the minimum consumption and the maximum consumption to predict the resource cost.

In some embodiments of the present disclosure, the operations may include training the graph neural network model for adversarial attacks.

In some embodiments of the present disclosure, the operations may include confirming a model result using a maximum cut method.

In some embodiments of the present disclosure, the model may be a deep learning model. In some embodiments, the operations may include updating parameters of a deep neural network of the deep learning model.

In some embodiments of the present disclosure, the operations may include adopting the model within a first specified time period, wherein parameters are updated within a second specified time period to enable adopting the model within the first specified time period.

In some embodiments of the present disclosure, the operations may include providing a real-time response to an incoming request with the model.

In some embodiments of the present disclosure, the operations may include balancing, rebalancing, or maintaining a balance of a system, wherein the system includes the node and at least one other node. In some embodiments, the nodes in the system may offer the same service. In some embodiments, reinforcement learning may be used to balance, rebalance, and/or maintain the balance of the system.

In some embodiments of the present disclosure, the model may initially be trained via simulation, e.g., using simulated data.

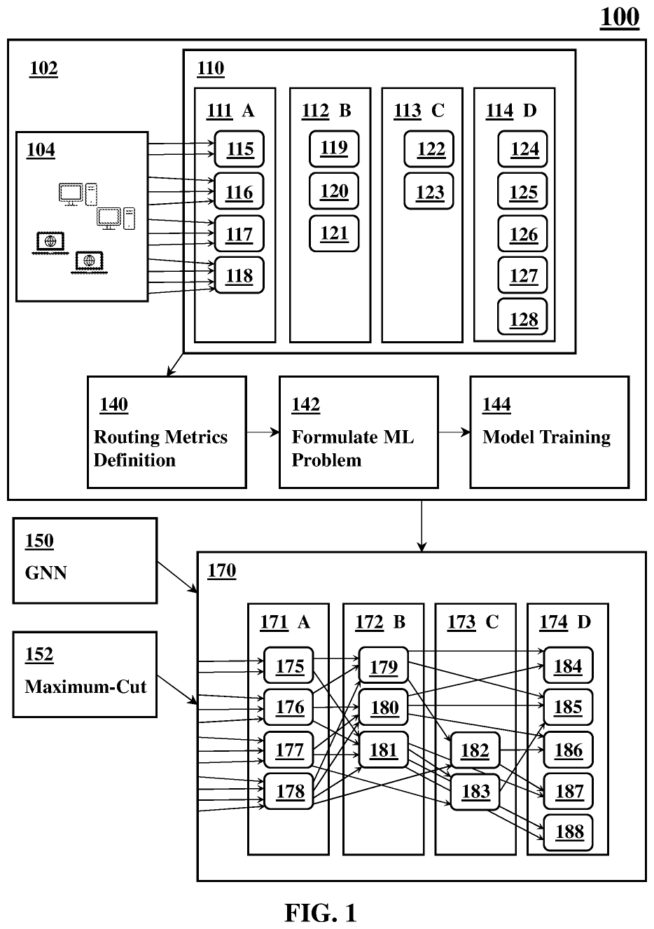

FIG. 1 illustrates a system 100 of intelligent microservice workload routing in accordance with some embodiments of the present disclosure. The system 100 includes an environment 102 wherein user devices 104 are requesting resources from a cluster 110. The cluster 110 includes pods 111-114. Each of the pods 111-114 are located at nodes 115-128.

Upon receiving one or more resource requests from the user devices 104, the cluster 110 may engage a routing metrics definition 140 to formulate the ML problem 142 and commence model training 144. In some embodiments, the model training 144 may include classic ML training, simulation training, and/or reinforcement learning.

The model training 144 may employ various types of data to train the model; for example, real world data and/or simulation data may be used. In some embodiments, real world data and simulation data may be used; in embodiments using both real world data and simulation data, the real world data may be granted a higher weighting (e.g., treated with greater importance) than the simulation data. In some embodiments, a model may first be trained with simulation data and real world data may be used to correct for one or more unreasonable outputs based on the simulation data (e.g., real data may be used to reduce noise).

The model training 144 may include reinforcement learning training. In some embodiments, a simulation or simulation data may be used for an initial training of a model and then reinforcement learning may be used thereafter. In some embodiments, multiple iterations of reinforcement learning may be used before the model is deployed. It may be considered reasonable to train a model over ten iterations of reinforcement learning before deploying the model; in some embodiments, additional iterations may be preferred.

The environment 102 may deploy the model that was trained during model training 144 to route the resource requests from the user devices 104. The model may route the workloads from the resource requests throughout the cluster 170 such that the workloads are balanced among the pods 171-174 and the nodes 175-188. Balancing the workloads over the cluster 170 (e.g., over the pods 171-174 and/or the nodes 175-188 within the cluster) may improve the use (e.g., enable more efficient and/or faster use) of the resources. Selection of a node for a workload may depend on, for example, the resource cost (e.g., which node can fulfill the request the most efficiently and/or the most quickly) and workload balancing.

A GNN 150 may be used to improve the model stability; for example, a GNN 150 may employ adversarial attacks to reduce the noise in the data to improve model stability. The GNN model 150 may be used to reduce traffic noise and/or improve the route selection for a workload.

The GNN 150 may be trained for adversarial attacks. An objective for adversarial attacks may be to misguide the model by minimizing attack loss. For example, using the GNN 150, an adversarial attack may modify the edges and features to confuse a predicted behavior, thereby assisting in the configuration of the next selected node. In some embodiments of the present disclosure, a GNN adversarial attack model may be used to improve the robustness of the prediction model by minimizing and/or avoiding false model results that may occur as the result of corrupted or incomplete source data and/or feature annotations. In some embodiments, the GNN 150 may be used in a black box query against the predictive model, or the GNN 150 may be unleashed against the predictive model in an unsupervised fashion.

The GNN 150 may be trained for adversarial attacks via one or more training strategies. In some embodiments, an adversarial training strategy with dynamic regularization may be used so as to perturb the input features. Such a training strategy may include the divergence between the prediction of the target example and the prediction of its connected examples in the objective adversarial training. The divergence may enable the GNN 150 to attack and reconstruct the relevant graph to improve smoothness of the graph. In some embodiments, batch virtual adversarial training may be used to promote smoothness of the GNN 150 and thereby make the GNN 150 more robust against adversarial perturbations.

The results from the model may be confirmed using the maximum cut method 152. The maximum cut method 152 may be used, for example, to identify, compare, address, and/or correct workload balances across the cluster 170.

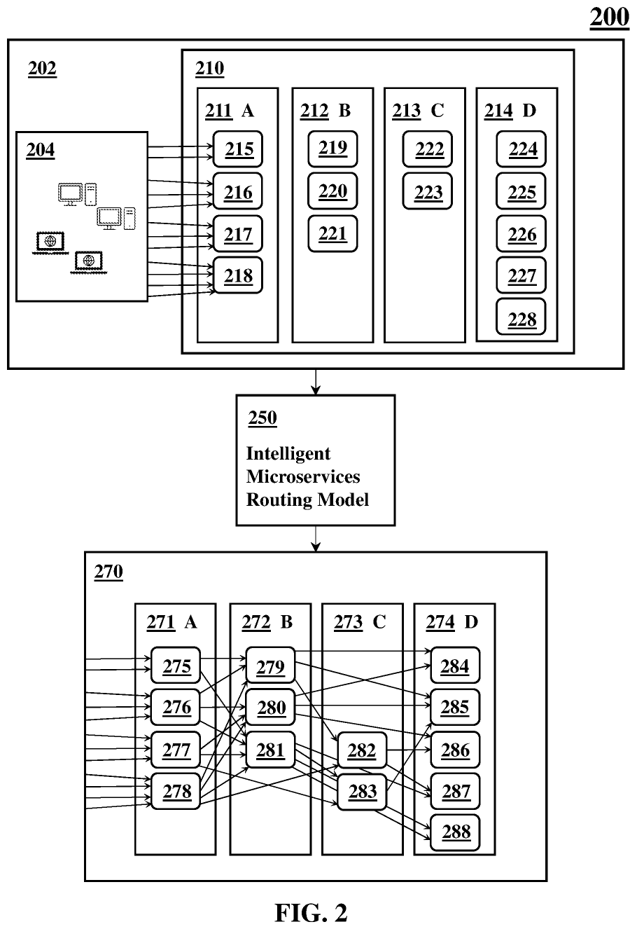

FIG. 2 depicts a system 200 of intelligent microservice workload routing in accordance with some embodiments of the present disclosure. The system 200 includes an environment 202 wherein user devices 204 are requesting resources from a cluster 210. The cluster 210 includes pods 211-214. Each of the pods 211-214 are located at nodes 215-228. Upon receiving one or more resource requests from the user devices 204, the cluster 210 may engage the intelligent microservices routing model 250 to route the workload requests from the user devices 204.

In some embodiments of the present disclosure, the intelligent microservices routing model 250 may be trained via, for example, classical ML, training via simulation (e.g., with simulation data), reinforcement learning, and the like.

The environment 202 may deploy the intelligent microservices routing model 250 to route resource requests. The intelligent microservices routing model 250 may route the workloads from the resource requests throughout the cluster 270 such that the workloads are balanced among the pods 271-274 and the nodes 275-288. Balancing the workloads over the cluster 270 (e.g., over the pods 271-274 and/or the nodes 275-288 within the cluster) may improve the use (e.g., enable more efficient and/or faster use) of the resources. Selection of a node for a workload may depend on, for example, the resource cost (e.g., which node can fulfill the request the most efficiently and/or the most quickly) and workload balancing.

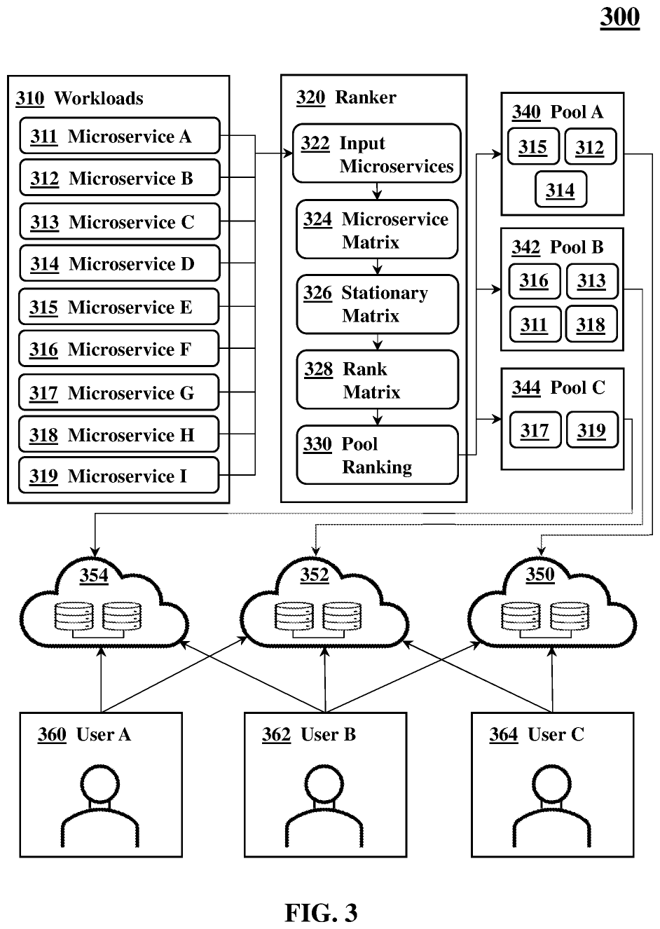

FIG. 3 illustrates a diagram 300 of microservice workload routing in accordance with some embodiments of the present disclosure. The diagram 300 includes workloads 310 pending service, a ranker 320, resource pools 340-344, cloud data centers 350-354, and users 360-364.

The diagram 300 includes various workloads 310. The workloads 310 include multiple microservices 311-319 requesting resources to complete tasks. The microservices 311-319 are submitted to a ranker 320. The ranker 320 receives the microservices 311-319 as input 322. The input 322 is submitted to a microservice matrix 324. The microservice matrix 324 produces an output that is submitted to a stationary matrix 326. The stationary matrix 326 submits an output to the rank matrix 328, and the rank matrix 328 submits an output for pool ranking 330.

The pool ranking 330 assigns the microservices 311-319 to the various resource pools 340-344 (e.g., clusters, pods, or nodes). The resource pools 340-344 may be hosted on one or more cloud data centers 350-354. Users 360-364 may access the microservices 311-319 via the cloud data centers 350-354.

In some embodiments of the present disclosure, a model (e.g., the intelligent microservices routing model 250 of FIG. 2) may be used as part of or in conjunction with the ranker 320 to identify, aggregate, rank, and/or assign the microservices 311-319. In some embodiments, a GNN (e.g., GNN 150 of FIG. 1) may be used to improve the stability of the model. In some embodiments, the result of the model may be assessed (e.g., confirmed using the maximum cut method 152 of FIG. 1).

In some embodiments, metrics, ML problem formulation, and model training (e.g., routing metrics definition 140, the ML problem 142, and model training 144 of FIG. 1) may be conducted to provide a model as an input into the ranker 320 such that the ranker 320 may use the model to identify, aggregate, rank, and/or assign the microservices 311-319.

A computer-implemented method in accordance with the present disclosure may include training a model. The method may include enhancing the model with reinforcement learning and improving stability of the model with a graph neural network model. The method may include predicting, with the model, a resource cost of a workload and deploying a node to host the workload.

In some embodiments of the present disclosure, the method may include generating a callback with an actual consumption and a predicted consumption and updating the model with the callback.

In some embodiments of the present disclosure, the method may include estimating a minimum consumption of the node, estimating a maximum consumption of the node, and using the minimum consumption and the maximum consumption to predict the resource cost.

In some embodiments of the present disclosure, the method may include training the graph neural network model for adversarial attacks.

In some embodiments of the present disclosure, the method may include confirming a model result using a maximum cut method.

In some embodiments of the present disclosure, the model may be a deep learning model. In some embodiments, the method may include updating parameters of a deep neural network of the deep learning model.

In some embodiments of the present disclosure, the method may include adopting the model within a first specified time period, wherein parameters are updated within a second specified time period to enable adopting the model within the first specified time period.

In some embodiments of the present disclosure, the method may include providing a real-time response to an incoming request with the model.

In some embodiments of the present disclosure, the method may include balancing, rebalancing, or maintaining a balance of a system, wherein the system includes the node and at least one other node. In some embodiments, the nodes in the system may offer the same service. In some embodiments, reinforcement learning may be used to balance, rebalance, and/or maintain the balance of the system.

In some embodiments of the present disclosure, the model may initially be trained via simulation, e.g., using simulated data.

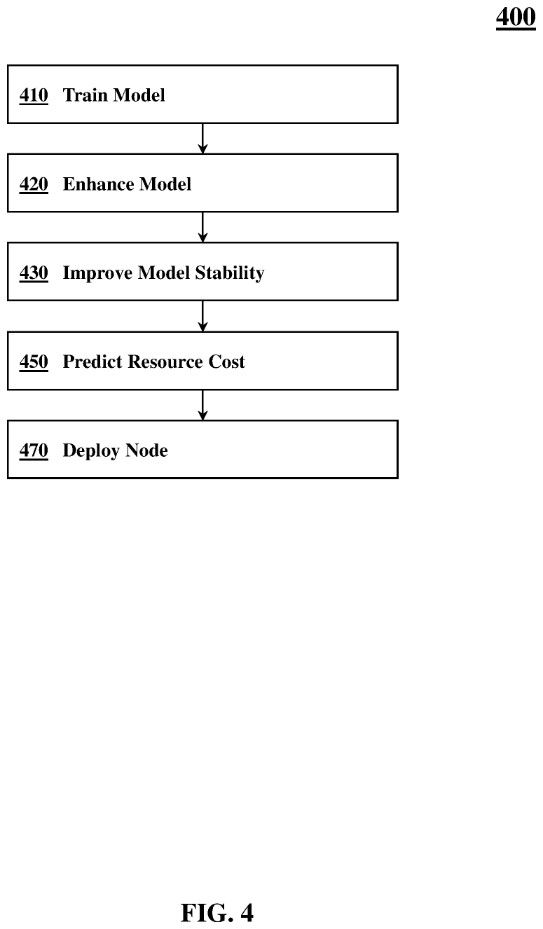

FIG. 4 depicts a method 400 of intelligent workload routing in accordance with some embodiments of the present disclosure. The method 400 may be used in a computer system environment (e.g., in the environment 102 of FIG. 1 or in the cluster 270 of FIG. 2). The method 400 includes training 410 a model and enhancing 420 the model. Enhancing 420 the model may include one or more avenues, such as utilizing one or more ML techniques (e.g., classical ML training and/or reinforcement learning). The method 400 includes improving 430 the stability of the model; the stability of the model may be improved, for example, using a GNN model to improve the robustness of the model by minimizing noise.

The method 400 includes predicting 450 the resource cost of a workload with the model. In some embodiments, predicting 450 the resource cost of the workload may include estimating the minimum resource cost and the maximum resource cost of the workload and using the estimations to predict the workload resource cost.

The method 400 includes deploying 470 a node to host the workload. In some embodiments, the model will select an optimal node to host the workload; for example, the optimal node may be the node best suited to a specific goal, e.g., to complete the workload in the least amount of time, start the workload the fastest, and/or run the workload with the best efficiency.

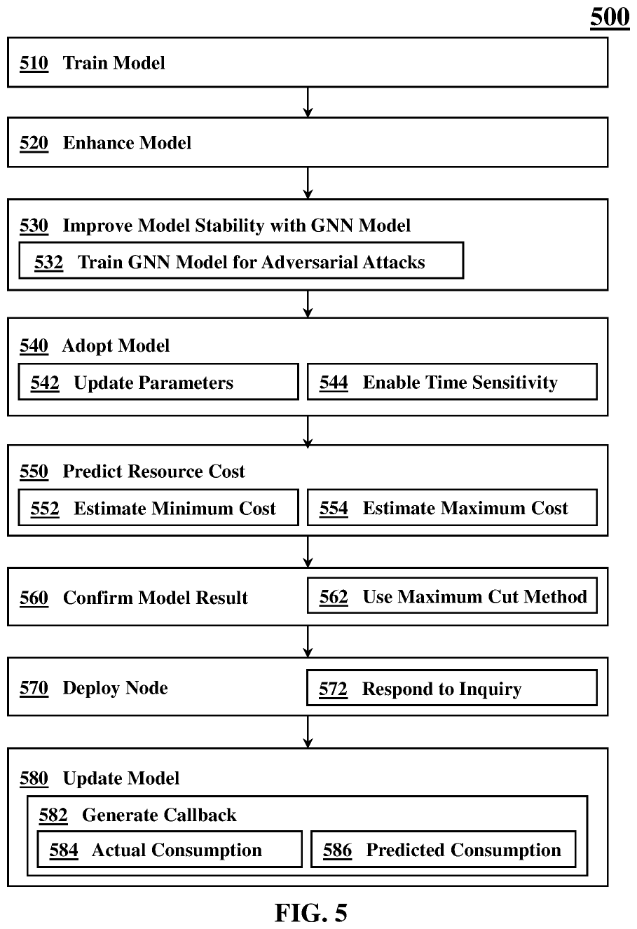

FIG. 5 illustrates a method 500 of intelligent workload routing in accordance with some embodiments of the present disclosure. The method 500 may be used in a cloud environment and/or in an open-source container environment (e.g., in the environment 102 of FIG. 1 or in the cluster 270 of FIG. 2). The method 500 includes training 510 a model and enhancing 520 the model. In some embodiments of the present disclosure, enhancing 520 the model may be done with ML such as reinforcement learning.

The method 500 includes improving 530 the stability of the model using a GNN model. The method 500 may include training 532 the GNN model for adversarial attacks. The GNN model trained for adversarial attacks may be used to improve the model by correcting for data noise (e.g., by excluding unreasonable data from the model or by minimizing the impact of unreasonable data on the model). The GNN model may be used to reduce traffic noise and/or improve the route selection for a workload.

The method 500 includes adopting 540 the model; in some embodiments, the model may be adopted within a specified time period (e.g., before a task deadline). The method 500 may include updating 542 the parameters. In some embodiments, the parameters may be updated within a certain time frame such that the model may be adopted within a specified time period; updating 542 the parameters within a time frame so as to adopt the model within a specified time period may be referred to as enabling 544 time sensitivity.

For example, a DNN may be used to train a predictive model. The DNN may employ reinforcement learning in training and/or retraining the predictive model, and the parameters of the DNN may be updated between training s of the predictive model. The predictive model may be scheduled to perform a task within a short period of time, e.g., in three seconds; the parameters of the DNN may be updated within a shorter period of time, e.g., within fifty milliseconds, such that the predictive model may be used for predicting 550 a resource cost and deploying 560 a node within identified time parameters. In such an example, the parameters were updated within the time frame of fifty milliseconds so that the predictive model could perform the task within the specified time period of three seconds.

The method 500 includes predicting 550 the resource cost of a node using the model. In some embodiments, predicting 550 the resource cost of the node may include estimating 552 the minimum cost of the node and estimating 554 the maximum cost of the node. In some embodiments, the minimum cost of the node and the maximum cost of the node may be identical or nearly identical. For example, in some embodiments, nearly identical cost estimations may mean the minimum cost of the node is within one standard deviation of the maximum cost of the node; in some embodiments, nearly identical cost estimations may mean that the minimum cost of the node is at least 95% of the maximum cost of the node. In some embodiments of the present disclosure, nearly identical cost estimations may mean that the minimum cost of the node is at least 98% of the maximum cost of the node.

The method 500 includes confirming 560 a model result. Various mechanisms, including those currently known or later to be discovered in the art, may be used to confirm the model result. In some embodiments, confirming 560 the model result may include using 562 the maximum cut method.

The method 500 includes deploying 570 the node. In some embodiments, the node may be deployed when the method 500 is used while responding 572 to an inquiry such as, for example, a real-time inquiry.

The method 500 includes updating 580 the predictive model. In some embodiments, updating 580 the model may include generating 582 a callback; generating 582 a callback may include identifying an actual consumption 584 and comparing it to the predicted consumption 586. The callback may be used to update the predictive model.

A computer program product in accordance with the present disclosure may include a computer readable storage medium having program instructions embodied therewith. The program instructions may be executable by a processor to cause the processor to perform a function. The function may include training a model. The function may include enhancing the model with reinforcement learning and improving stability of the model with a graph neural network model. The function may include predicting, with the model, a resource cost of a workload and deploying a node to host the workload.

In some embodiments of the present disclosure, the function may include generating a callback with an actual consumption and a predicted consumption and updating the model with the callback.

In some embodiments of the present disclosure, the function may include estimating a minimum consumption of the node, estimating a maximum consumption of the node, and using the minimum consumption and the maximum consumption to predict the resource cost.

In some embodiments of the present disclosure, the function may include training the graph neural network model for adversarial attacks.

In some embodiments of the present disclosure, the function may include confirming a model result using a maximum cut method.

In some embodiments of the present disclosure, the model may be a deep learning model. In some embodiments, the function may include updating parameters of a deep neural network of the deep learning model.

In some embodiments of the present disclosure, the function may include adopting the model within a first specified time period, wherein parameters are updated within a second specified time period to enable adopting the model within the first specified time period.

In some embodiments of the present disclosure, the function may include providing a real-time response to an incoming request with the model.

In some embodiments of the present disclosure, the function may include balancing, rebalancing, or maintaining a balance of a system, wherein the system includes the node and at least one other node. In some embodiments, the nodes in the system may offer the same service. In some embodiments, reinforcement learning may be used to balance, rebalance, and/or maintain the balance of the system.

In some embodiments of the present disclosure, the model may initially be trained via simulation, e.g., using simulated data.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

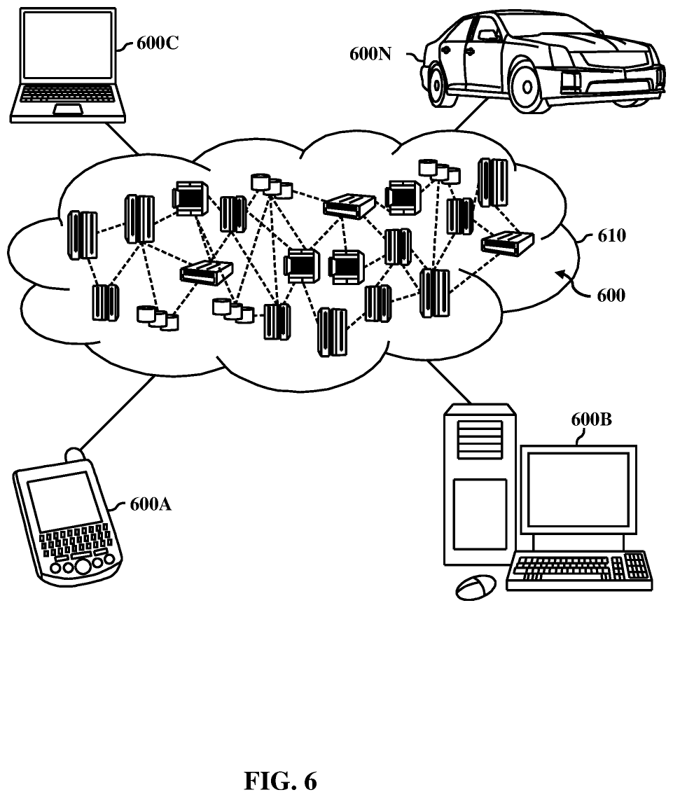

FIG. 6 illustrates a cloud computing environment 610 in accordance with embodiments of the present disclosure. As shown, cloud computing environment 610 includes one or more cloud computing nodes 600 with which local computing devices used by cloud consumers such as, for example, personal digital assistant (PDA) or cellular telephone 600A, desktop computer 600B, laptop computer 600C, and/or automobile computer system 600N may communicate. Nodes 600 may communicate with one another. They may be grouped (not shown) physically or virtually, in one or more networks, such as private, community, public, or hybrid clouds as described hereinabove, or a combination thereof.

This allows cloud computing environment 610 to offer infrastructure, platforms, and/or software as services for which a cloud consumer does not need to maintain resources on a local computing device. It is understood that the types of computing devices 600A-N shown in FIG. 6 are intended to be illustrative only and that computing nodes 600 and cloud computing environment 610 can communicate with any type of computerized device over any type of network and/or network addressable connection (e.g., using a web browser).

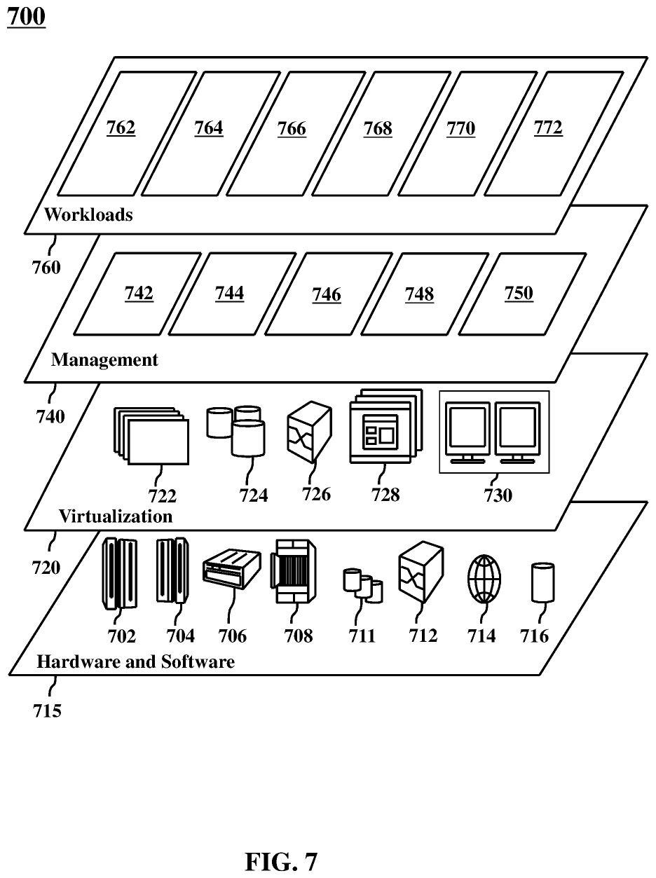

FIG. 7 illustrates abstraction model layers 700 provided by cloud computing environment 610 (FIG. 6) in accordance with embodiments of the present disclosure. It should be understood in advance that the components, layers, and functions shown in FIG. 7 are intended to be illustrative only and embodiments of the disclosure are not limited thereto. As depicted below, the following layers and corresponding functions are provided.

Hardware and software layer 715 includes hardware and software components. Examples of hardware components include: mainframes 702; RISC (Reduced Instruction Set Computer) architecture-based servers 704; servers 706; blade servers 708; storage devices 711; and networks and networking components 712. In some embodiments, software components include network application server software 714 and database software 716.

Virtualization layer 720 provides an abstraction layer from which the following examples of virtual entities may be provided: virtual servers 722; virtual storage 724; virtual networks 726, including virtual private networks; virtual applications and operating systems 728; and virtual clients 730.

In one example, management layer 740 may provide the functions described below. Resource provisioning 742 provides dynamic procurement of computing resources and other resources that are utilized to perform tasks within the cloud computing environment. Metering and pricing 744 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 746 provides access to the cloud computing environment for consumers and system administrators. Service level management 748 provides cloud computing resource allocation and management such that required service levels are met. Service level agreement (SLA) planning and fulfillment 750 provide pre-arrangement for, and procurement of, cloud computing resources for which a future requirement is anticipated in accordance with an SLA.

Workloads layer 760 provides examples of functionality for which the cloud computing environment may be utilized. Examples of workloads and functions which may be provided from this layer include: mapping and navigation 762; software development and lifecycle management 764; virtual classroom education delivery 766; data analytics processing 768; transaction processing 770; and intelligent workload routing for microservices 772.

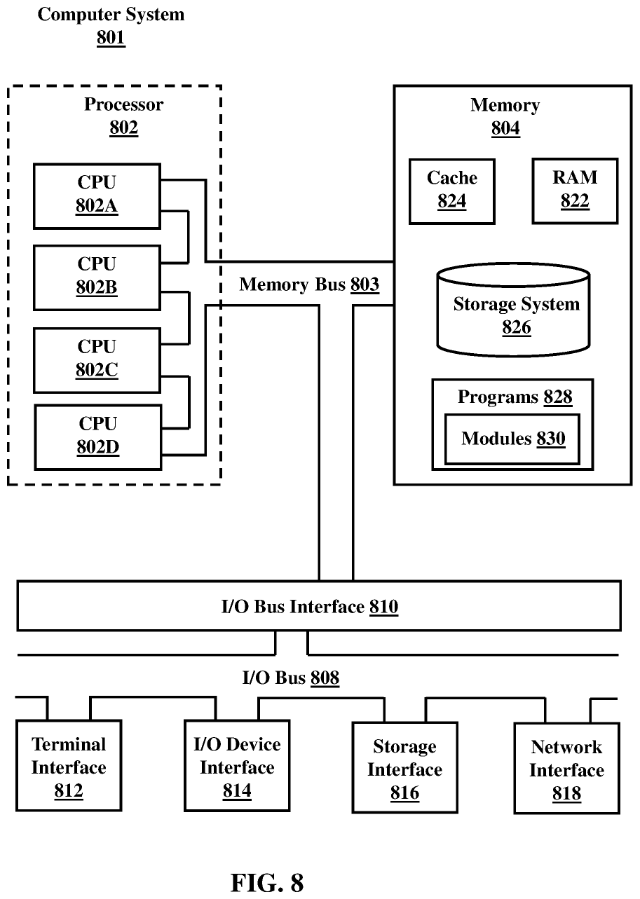

FIG. 8 illustrates a high-level block diagram of an example computer system 801 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 801 may comprise a processor 802 with one or more central processing units (CPUs) 802A, 802B, 802C, and 802D, a memory subsystem 804, a terminal interface 812, a storage interface 816, an I/O (Input/Output) device interface 814, and a network interface 818, all of which may be communicatively coupled, directly or indirectly, for inter-component communication via a memory bus 803, an I/O bus 808, and an I/O bus interface unit 810.

The computer system 801 may contain one or more general-purpose programmable CPUs 802A, 802B, 802C, and 802D, herein generically referred to as the CPU 802. In some embodiments, the computer system 801 may contain multiple processors typical of a relatively large system; however, in other embodiments, the computer system 801 may alternatively be a single CPU system. Each CPU 802 may execute instructions stored in the memory subsystem 804 and may include one or more levels of on-board cache.

System memory 804 may include computer system readable media in the form of volatile memory, such as random access memory (RAM) 822 or cache memory 824. Computer system 801 may further include other removable/non-removable, volatile/non-volatile computer system storage media. By way of example only, storage system 826 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 804 can include flash memory, e.g., a flash memory stick drive or a flash drive. Memory devices can be connected to memory bus 803 by one or more data media interfaces. The memory 804 may include at least one program product having a set (e.g., at least one) of program modules that are configured to carry out the functions of various embodiments.

One or more programs/utilities 828, each having at least one set of program modules 830, may be stored in memory 804. The programs/utilities 828 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 828 and/or program modules 830 generally perform the functions or methodologies of various embodiments.

Although the memory bus 803 is shown in FIG. 8 as a single bus structure providing a direct communication path among the CPUs 802, the memory subsystem 804, and the I/O bus interface 810, the memory bus 803 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 810 and the I/O bus 808 are shown as single respective units, the computer system 801 may, in some embodiments, contain multiple I/O bus interface units 810, multiple I/O buses 808, or both. Further, while multiple I/O interface units 810 are shown, which separate the I/O bus 808 from various communications paths running to the various I/O devices, in other embodiments some or all of the I/O devices may be connected directly to one or more system I/O buses 808.

In some embodiments, the computer system 801 may be a multi-user mainframe computer system, a single-user system, a server computer, or similar device that has little or no direct user interface but receives requests from other computer systems (clients). Further, in some embodiments, the computer system 801 may be implemented as a desktop computer, portable computer, laptop or notebook computer, tablet computer, pocket computer, telephone, smartphone, network switches or routers, or any other appropriate type of electronic device.

It is noted that FIG. 8 is intended to depict the representative major components of an exemplary computer system 801. In some embodiments, however, individual components may have greater or lesser complexity than as represented in FIG. 8, components other than or in addition to those shown in FIG. 8 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
training a model;
enhancing said model with reinforcement learning;
improving stability of said model with a graph neural network model;
predicting, with said model, a resource cost of a workload; and
deploying a node to host said workload.

2. The system of claim 1, said operations further comprising:
generating a callback with an actual consumption and a predicted consumption; and
updating said model with said callback.

3. The system of claim 1, said operations further comprising:
estimating a minimum consumption of said workload and a maximum consumption of said workload; and
using said minimum consumption and said maximum consumption to predict said resource cost.

4. The system of claim 1, said operations further comprising:
training said graph neural network model for adversarial attacks.

5. The system of claim 1, said operations further comprising:
confirming a model result using a maximum cut method.

6. The system of claim 1, said operations further comprising:
adopting said model within a first specified time period, wherein parameters are updated within a second specified time period to enable adopting said model within said first specified time period.

7. The system of claim 1, said operations further comprising:
providing a real-time response to an incoming request with said model.

8. A computer-implemented method, said method comprising:
training a model;
enhancing said model with reinforcement learning;
improving stability of said model with a graph neural network model;
predicting, with said model, a resource cost of a workload; and
deploying a node to host said workload.

9. The computer-implemented method of claim 8, further comprising:
generating a callback with an actual consumption and a predicted consumption; and
updating said model with said callback.

10. The computer-implemented method of claim 8, further comprising:
estimating a minimum consumption of said workload and a maximum consumption of said workload; and
using said minimum consumption and said maximum consumption to predict said resource cost.

11. The computer-implemented method of claim 8, further comprising:
training said graph neural network model for adversarial attacks.

12. The computer-implemented method of claim 8, further comprising:
confirming a model result using a maximum cut method.

13. The computer-implemented method of claim 8, further comprising:
adopting said model within a first specified time period, wherein parameters are updated within a second specified time period to enable adopting said model within said first specified time period.

14. The computer-implemented method of claim 8, further comprising:
providing a real-time response to an incoming request with said model.

15. A computer program product, said computer program product comprising a computer readable storage medium having program instructions embodied therewith, said program instructions executable by a processor to cause said processor to perform a function, said function comprising:
training a model;
enhancing said model with reinforcement learning;
improving stability of said model with a graph neural network model;
predicting, with said model, a resource cost of a workload; and
deploying a node to host said workload.

16. The computer program product of claim 15, said function further comprising:
generating a callback with an actual consumption and a predicted consumption; and
updating said model with said callback.

17. The computer program product of claim 15, said function further comprising:
estimating a minimum consumption of said workload and a maximum consumption of said workload; and
using said minimum consumption and said maximum consumption to predict said resource cost.

18. The computer program product of claim 15, said function further comprising:
training said graph neural network model for adversarial attacks.

19. The computer program product of claim 15, said function further comprising:
confirming a model result using a maximum cut method.

20. The computer program product of claim 15, said function further comprising:
adopting said model within a first specified time period, wherein parameters are updated within a second specified time period to enable adopting said model within said first specified time period.
